(19) United States
(12) Patent Application Publication
(10) Pub. No.: US 2006/0284035 A1
(43) Pub. Date: Dec. 21, 2006

(54) Collapsible target stand

(76) Inventor: Robert Henry Crosby, Chapin, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/125,686

(22) Filed: May 10, 2005

(51) Int. Cl. F16M 13/00

(52) U.S. Cl. 248/158

(57) ABSTRACT

A portable target stand for supporting at least one shooting target includes: (a) a lower stand assembly including a substantially hollow primary tube, and a slide hammer that is slidable up and down an outside portion of the primary tube; (b) an upper stand assembly including a substantially hollow secondary tube that telescopes into and out of the primary tube; (c) at least one removable target support arm extendable at about a right angle from the primary tube or the secondary tube; (d) at least one target support arm coupling mechanism for coupling the target support arms to the primary tube or secondary tube; and (e) a number of target attachment devices for detachably attaching the target to the target support arms; wherein the upper stand assembly is collapsible into the primary tube to form a compact, self-contained carrying case when the target stand device is not in use.

### BACKGROUND OF THE INVENTION

1. Technical Field

The present invention relates to a target stand for holding and supporting at least one shooting target in the ground during target practice, more particularly, a portable target stand that is easily collapsed into a compact, self-contained form.

2. Background Information

A variety of target stands are currently taught, which are said to be portable. Some of them are complicated and would require quite a bit of time to assemble and disassemble. Conventional firearm shooting targets are detachably attached to these target stands by various means, including clips and clamps. Target stands with end posts that can be inserted into the ground are included among them.

Setting up a target stand on a range can be unnecessarily complicated. Sometimes a user gets all the way out to the end of the range only to realize that he or she forgot to bring a hammer, or a stapler. Most currently available target stands require a hammer to drive the stand post or posts into the ground, and a stapler to staple the target onto the stand. Even if the user is organized enough to collect his or her tools, ammunition, shooting rest, etc. in a carry-all box, conventional target stands are too big to fit into such carry-all boxes. In contrast, the compact, collapsible target stand of the present invention is not at all cumbersome, and is easy to carry out to the range, since it collapses down into a self-contained carrying case for transportation and storage. Since the present, lightweight target stand does not require the use of a hammer or stapler, the user's overall load is lightened, and assembling the target stand is easier.

Other advantages of the target stand device of the present invention include the following:

1) The present target stand functions as a carrying case, occupies a minimal amount of space, and is easy to transport and store.

2) The target stand of the present invention supports a number of easy to remove targets, so the targets need not be changed out as often.

3) Targets need not be folded up for transport; they can be rolled up and stored in a tube along with the rest of the target stand.

4) The present target stand sturdily supports a wide variety of conventional shooting targets, regardless of whether they are thick or thin, paper or plastic.

5) The distance between the upper and lower target support arms of the present invention relative is adjustable to accommodate various sizes of targets.

6) The target stand of the present invention is easy to drive into the ground using the built-in slide hammer.

7) The present target stand is quick and easy to assemble and disassemble; no tools are required.

### BRIEF SUMMARY OF THE INVENTION

The present invention is a collapsible, portable target stand device for holding and supporting at least one shooting target in the ground, which comprises:

(a) a lower stand assembly comprising a substantially hollow primary tube, and a slide hammer that is slidable up and down an outside portion of the primary tube;

(b) an upper stand assembly comprising a substantially hollow secondary tube with a smaller outside diameter than the inside diameter of the primary tube, the secondary tube being telescopable into and out of the primary tube;

(c) at least one removable target support arm, which is extendable at about a right angle from the primary tube or the secondary tube;

(d) at least one target support arm coupling mechanism for coupling the target support arms to the primary tube or secondary tube; and

(e) a plurality of target attachment devices for detachably attaching the target to the target support arm.

A majority of the secondary tube telescopes into and out of the primary tube. When the target stand device is not in use, at least a portion of the upper stand assembly collapses into the primary tube to form a compact, self-contained carrying case. The target stand device preferably further comprises an adjustable target support arm adjustment mechanism attached to the primary tube for adjusting the position of the secondary tube in the primary tube and thus the distance between the upper and lower target support arms.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a front perspective view of a target stand device according to the present invention, shown in a ready for use position with targets attached;

FIG. 2 is a front view of a target stand device according to the present invention, showing a parts breakdown;

FIG. 3 is a front perspective view of a target stand device according to the present invention, shown in its compact, self-contained transport position with target clasps and target support arms stored within the secondary tube;

FIG. 4 is a front perspective view of a target stand device according to the present invention, shown in a partially assembled state with the end plug, four target support arms, and eight target clasps outside the secondary tube;

FIG. 5 is a front perspective view of a target stand device according to the present invention, shown in a partially assembled state with the end plug in its storage position, and the four target support arms connected to the upper and lower stand assemblies;

FIGS. 6, 7, and 8 are front, side and top views, respectively, of a lower stand assembly of the target stand device according to FIG. 5;

FIGS. 9 and 10 are front and side views, respectively, of an upper stand assembly of the target stand device according to FIG. 5;

FIG. 11 is a front view of a target support arm of the target stand device according to FIG. 5;

FIGS. 12 and 13 are front and side views, respectively, of a target arm hinge coupling assembly of a target stand device according to the present invention; and

FIG. 14 is a top plan view of the target arm hinge coupling assembly of a target stand device according to FIG. 12.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

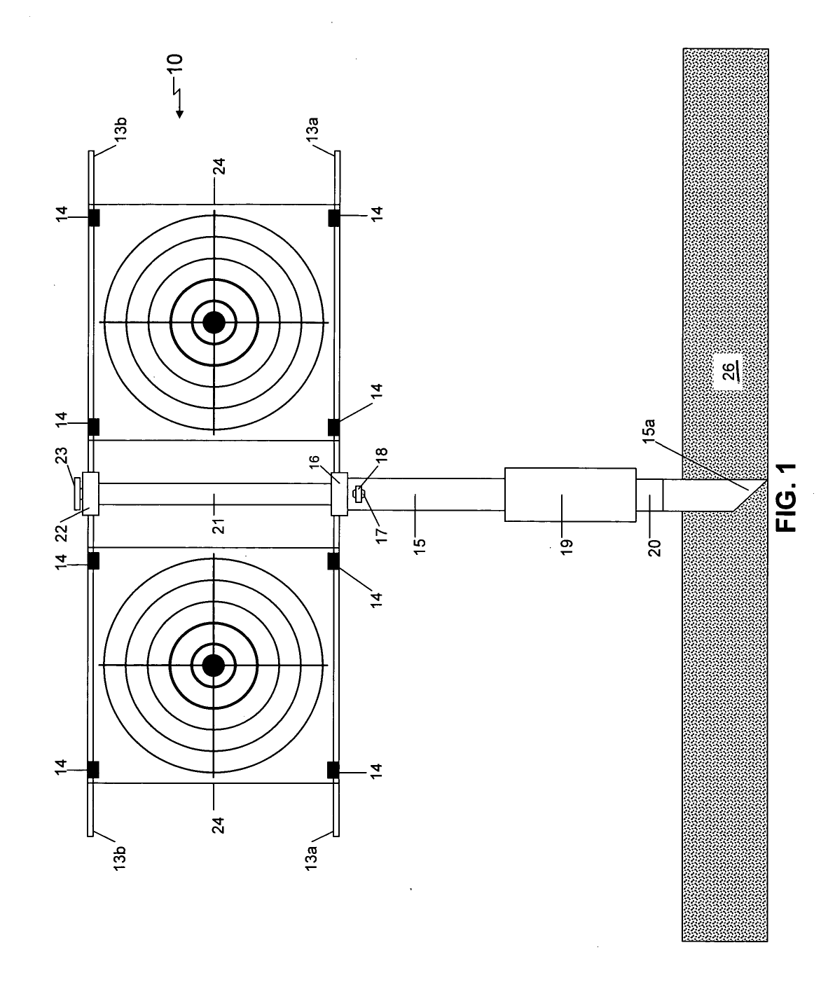

Turning first to FIGS. 1 through 4, a target stand device 10 according to the present invention for supporting at least one removable shooting target 24 in the ground includes the following:

(a) a lower, or first, stand assembly 11 comprising a substantially hollow primary tube 15, which preferably has a pointed end portion 15a, and a slide hammer 19 that is slidable up and down an outside portion of the primary tube 15;

(b) an upper, or second, stand assembly 12 comprising a secondary tube 21 with a smaller outside diameter than the primary tube 15, and an end plug 23 that is insertable into an end of the secondary tube 21;

(c) at least one removable target support arm 13, which is extendable at about a right angle from the primary tube 15 or the secondary tube 21;

(d) at least one target support arm coupling mechanism 28 for coupling the target support arms 13 to the primary tube 15 or secondary tube 21; and

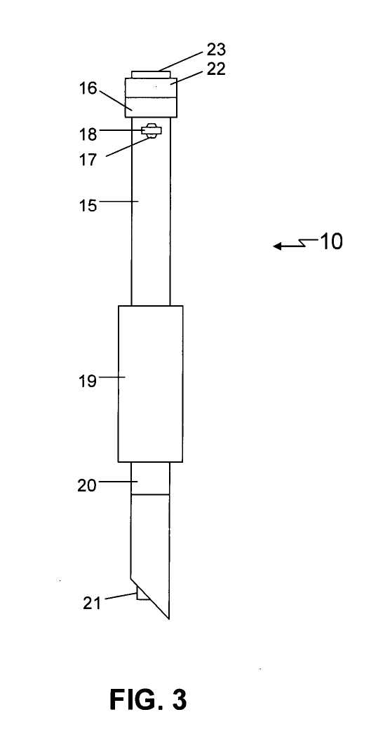

(e) a plurality of target attachment devices 14 for detachably attaching the target to the target support arms 13. A majority of the secondary tube 21 telescopes into and out of the primary tube 15. At least a portion of the upper stand assembly 12 is collapsible into the lower stand assembly 11 to form a compact, self-contained carrying case, as shown in FIG. 3. This carrying case/target stand is easy to transport and store in the home (e.g., in a gun cabinet), garage, shooting equipment box, etc. The target attachment devices 14 are preferably target clasps for clasping the targets without causing damage to the targets.

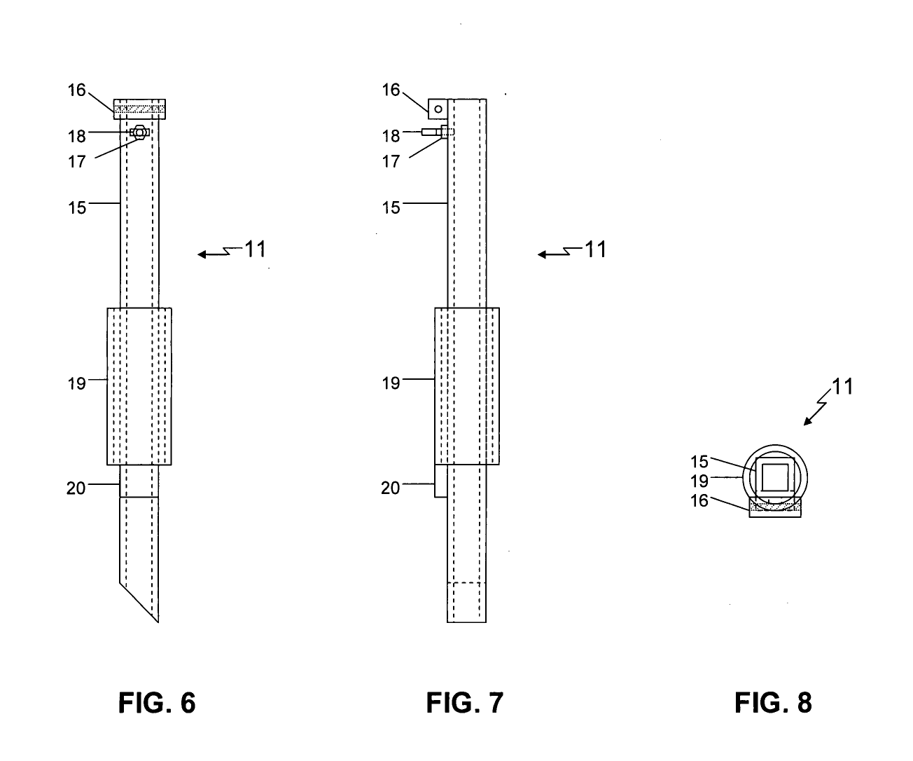

Referring to FIGS. 6 through 8, the lower stand assembly 11 preferably further includes a captive adjustment nut 17, an adjustment screw 18, and a strike plate 20. The slide hammer 19 fits closely around the outside of the primary tube 15. The primary tube has a smooth outer face so the slide hammer slides easily over it. The slide hammer 19 is preferably a relatively heavy steel tube that is about one third as long as the primary tube 15, and slides up and down the length of the primary tube 15. As seen in FIG. 8, the primary tube 15 is preferably square in shape. (The tube transverse cross-section is preferably rectangular, though a round cross-section is also suitable.) The square shape is beneficial in that it prevents unnecessary rotation from the wind, which is especially desirable since the targets can act as sails. The square-shaped primary tube 15 stays in the ground and the secondary tube 21 is less likely to twist around in the primary tube 15. As seen in FIGS. 6 and 7, the primary tube has a strike plate 20 attached to it, preferably by welding, just below the level of the slide hammer 19. The strike plate prevents the slide hammer 19 from sliding off the end of the primary tube 15. The slide hammer 19 is preferably round and about one fourth the length of the primary tube (i.e., most preferably between about six and eight inches in length).

As shown in FIGS. 1-8, there are preferably four target support arms and two target arm coupling mechanisms 28 (one for each set of target support arms), which are preferably the same type of mechanism as one another. The target support arm coupling mechanisms 28 are preferably an upper target arm support coupling nut 22, and a lower target arm support coupling nut 16, respectively. The coupling nuts 16, 22 are for detachably attaching the target support arms 13 to the primary or secondary tube 15, 21.

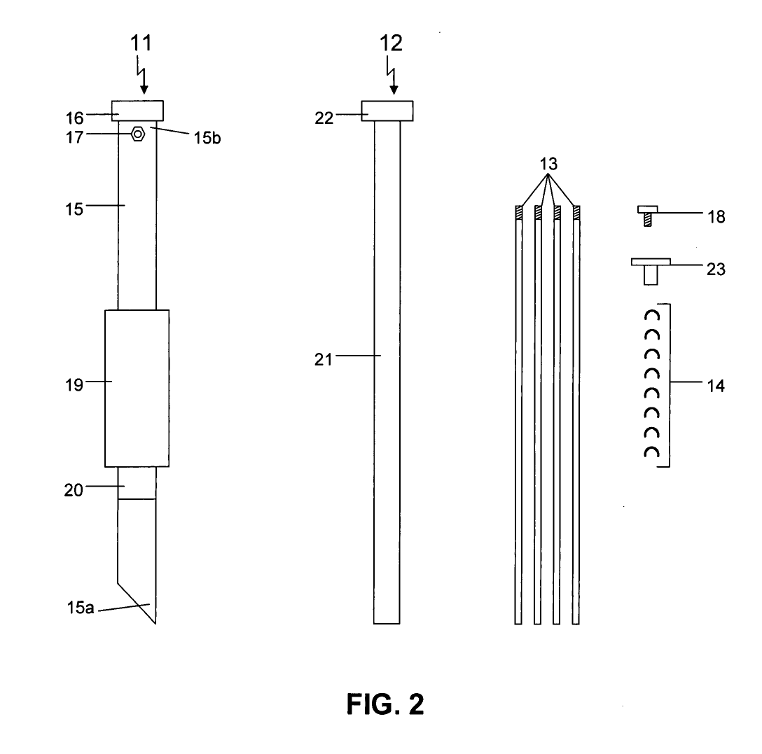

Continuing with FIGS. 1 and 2, the substantially hollow primary tube 15, which has a lower, pointed end portion 15a, also includes an upper, squared-off opposite end portion 15b for accommodating a lower end of the secondary tube 21. The pointed end portion 15a facilitates implantation of the target stand device 10 into the ground 26, as shown in FIG. 1. The end portion of the primary tube may alternatively be rounded. The primary tube 15 is preferably several feet in length, most preferably between about 20 and 24 inches in length.

By “upper” and “lower” herein is meant that the upper (or second) stand assembly 12 is above the lower (or first) stand assembly 11 when the target stand device 10 is in an upright, ready for use position, as shown in FIG. 1. The target stand 10 is, of course, in this position when it is in the ground ready for use. The two sets of target support arms 13 on opposite sides of the primary and secondary tubes are called “left” and “right” target support arms here. Each set of target support arms includes a matching upper target support arm 13b and a lower target support arm 13a, which is below the upper target support arm when the target stand device 10 is in the ready for use position. The upper target support arm 13b is generally parallel to the lower target support arm 13a when the target stand device 10 is in use.

To use the target stand device, the user attaches a desired number of targets 24 to the target support arms 13. The detachable targets 24 are preferably made of paper, including cardboard. The target stand device 10 accommodates a wide variety of target types, so the target 24 need not be of a certain length, width, or thickness. Since the distance between the target support arms 13 is adjustable, targets of various conventional sizes may be employed. A single target 24 may be hung between the left upper and lower target support arms 13a, b, or the right upper and lower target support arms 13a, b on the opposite side of the target stand. Alternatively, two targets 24 may be detachably attached to the target support arms 13, with one on each side of the target stand device 10, as shown in FIG. 1. Alternatively, up to four smaller size targets may be detachably attached to the upper and/or lower target support arms 13, two on each side of the stand. If desired, the upper edges of two targets may be hung down from the lower target support arms 13a, without being affixed on their lower edges. The target stand device 10 is intended for practicing target shooting on a range with a pistol, rifle, or other firearm, or an air gun.

As shown in FIGS. 1 through 7, the strike plate 20, which is preferably a metal collar welded to the primary tube 15 several (most preferably about three) inches above the pointed end 15a of the primary tube. The lower target arm coupling nut 16 is attached, preferably by welding, to the surface of the primary tube 15 at level with the squared off end portion of the primary tube 15b. The lower target arm coupling nut 16 is used to detachably attach the lower target support arms 13a to the target stand device 10.

The adjustable target support arm adjustment mechanism 27 for adjusting the distance of the upper and lower target support arms 13a, b relative to one another preferably includes a captive adjustment nut 17 and an adjustment screw 18. The threaded captive adjustment nut 17 is preferably welded to the primary tube 15 during manufacture of the device 10 just (most preferably about one inch) below the lower target arm coupling nut 16. Using the hole in the threaded adjustment nut, a hole is then drilled through the wall of the primary tube, and the newly formed hole is re-tapped. The adjustment screw 18 is then screwed into the captive adjustment nut 17. The end of the adjustment screw 18 impinges upon the secondary tube 21 and is used to adjust and lock the position of the secondary tube 21, which telescopes within the primary tube 15. The target stand device 10 is then ready for use. This arm adjustment mechanism 27 allows the user to lock the secondary tube in a desired position and to adjust the distance between the upper and lower target support arms 13a, b for best target fit.

The slide hammer 19 is captive and slides freely over the primary tube 15 between the strike plate 20 at the bottom and the adjustment screw 18 at the top. The presence of the adjustment screw 18 above and the strike plate 20 below physically prevents the slide hammer from sliding off either end of the primary tube 15. The slide hammer 19 is used to drive the pointed end 15a of the target stand device 10 into the ground. With one hand, the user holds the target stand device above the captive adjusting nut 17 in a vertical position with the pointed end 15a pushed into the ground. With the other hand, the user drives the target stand device 10 into the ground by rapidly pulling the slide hammer up and down and repeatedly striking the strike plate 20 with the slide hammer 19. Once it is erected and the targets 24 have been removably attached to the target arms 13, the target stand device is in a ready for use position.

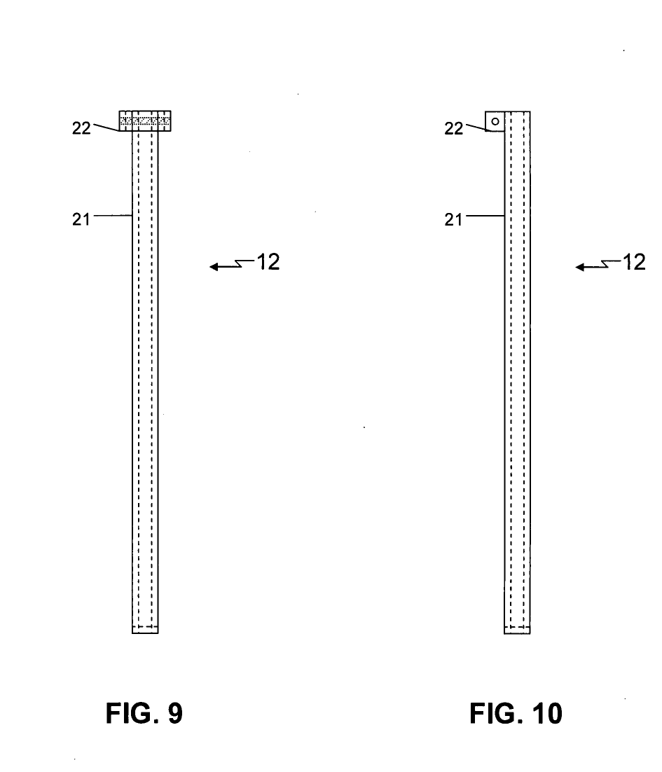

Referring to FIGS. 2 through 10, the upper stand assembly 12 includes a secondary tube 21, an upper coupling nut 22, and an end plug 23. The secondary tube 21 is sized to telescope within the primary tube 15 and is most preferably about the same length as the primary tube 15 (i.e., between about 20 and about 24 inches in length). As seen in FIG. 10, the secondary tube 21 is preferably squared at both ends, open at an upper end and closed at the opposite, lower end. The upper target arm coupling nut 22 is attached, preferably by welding, to the surface of the secondary tube 21 at a point level with the open, squared-off upper end portion of the secondary tube 21. The upper target arm coupling nut 22 is used to detachably attach the upper target support arms 13b to the target stand device 10. The upper target arm coupling nut 22 blocks the secondary tube 21 from sliding all the way into the primary tube 15. As seen in FIGS. 3, 9, and 10, the secondary tube 21 is secured within the hollow of the primary tube 15 using the adjusting screw.

For transport, the targets 24, target clasps 14, and/or the target support arms 13 are inserted into the hollow of the secondary tube 21. The secondary tube 21 is telescoped into the primary tube 15. The end plug 23 fits closely into the open upper end of the secondary tube, as shown in FIG. 3. This is the compact transport/storage position. The lower stand assembly 11 optionally includes a shoulder strap (not shown) for carrying the stand device 10 when it is in the compact transport position.

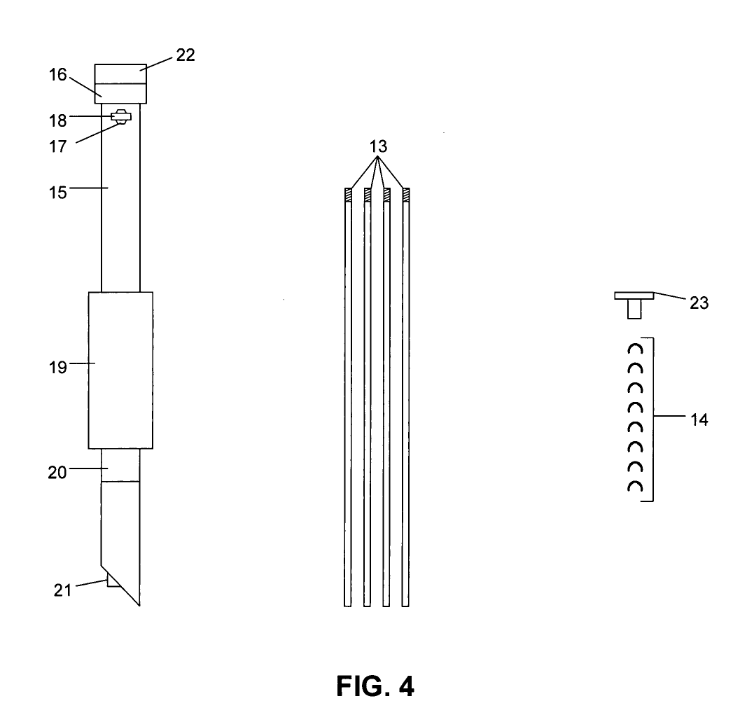

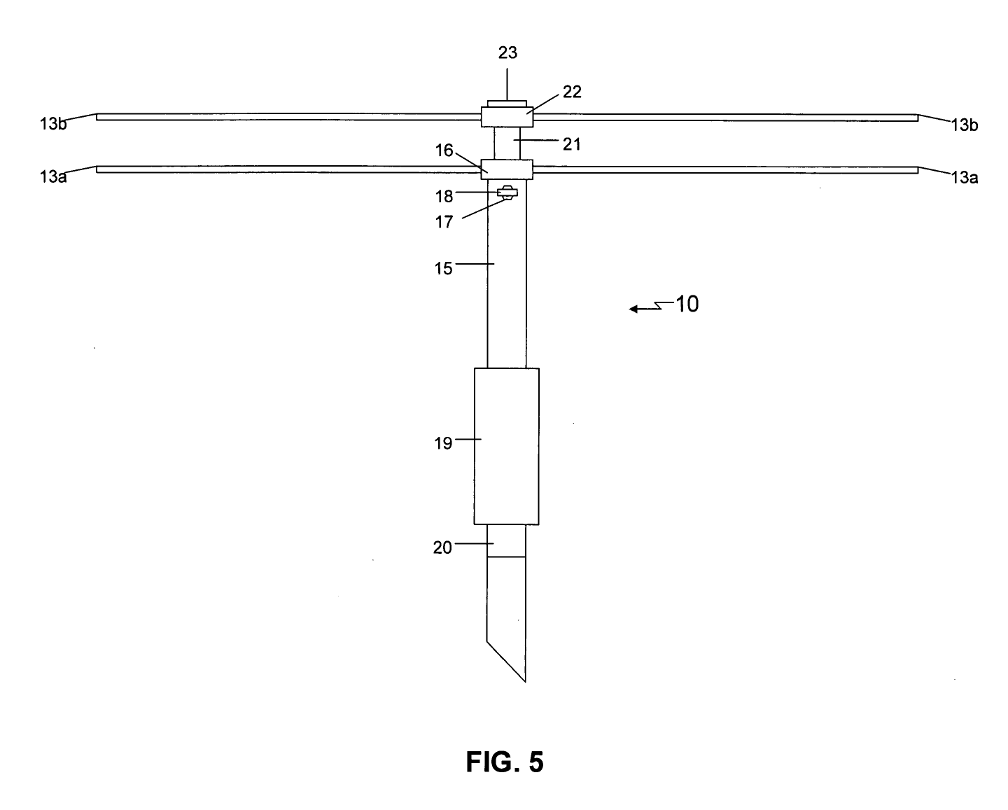

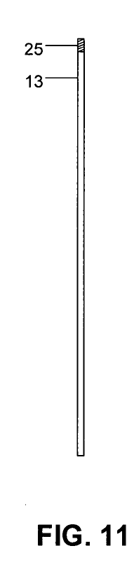

Referring to FIGS. 5 and 11, the target support arms 13 are removably insertable in the lower or upper target arm coupling nuts 16, 22, and are detachable for storage in the hollow of the secondary tube 21. As seen in FIG. 11, the target support arms 13 have a threaded end 25. The threading on the threaded end 25 corresponds to threading in the target arm coupling nuts 16, 22, so that one, or preferably two, target support arms 13 can be screwed into each coupling nut 16, 22 as the stand device 10 is assembled for use. Each target stand device 10 preferably includes four interchangeable target support arms 13 (see FIGS. 2 and 4), two upper and two lower.

In FIG. 1, the target stand device 10 is in a fully extended, ready for use position. In FIG. 5, the target stand device 10 is depicted- in an assembled, partially extended position, with the majority of the secondary tube 21 telescoped into the primary tube 15. The stand device 10 could less preferably be used in this position.

Referring to FIGS. 3-5, up to four target support arms 13, up to eight target clasps 14,and the targets 24 in a wound up configuration fit within the secondary tube 21. The secondary tube 21 telescopes into the primary tube 15 for storage and transport. The full primary tube 15 then forms the carrying case. The target support arms 13, the secondary tube 21, and the primary tube 15 are about the same length, with the latter being slightly longer than the secondary tube 21, and the secondary tube 21 being slightly longer than the target support arms 13 in order to easily accommodate the target support arms. The primary tube 15 has a larger inside diameter than the outside diameter of the secondary tube 21 in order to accommodate it. The secondary tube 21 has a larger inside diameter than the outside diameter of each of the target support arms 13 in order to hold them. The target support arms 13 are insertable in the secondary tube 21. The slide hammer 19 has a larger inside diameter than the outside diameter of the primary tube 15, soothe slide hammer can slide on the smooth primary tube. An end plug 23 is preferably placed into the end of the secondary tube 21 prior to transport. One or more of the targets 24 can also be rolled around the target support arms 13 and all are inserted into the hollow of the secondary tube 21 for neat storage and transport.

To assemble the target stand device 10, the end plug 23 is removed from the secondary tube and the parts are removed from the secondary tube 21 (see FIG. 4). The target support arms 13 are screwed into the target arm coupling nuts 16, 22. To ready the target stand device for use, the pointed end portion 15a of the lower stand assembly 11 is pushed into the ground, so that the target stand device 10 is approximately perpendicular to the ground 26 (see FIG. 1). It can be seen that the target stand device 10 is useful regardless of the slope or evenness of the ground. The slide hammer 19 is slammed several times against the strike plate 20 until the target stand device 10 is firmly secured in the ground 26.

The targets 24 are then unfurled, and the distance between the upper and lower target support arms 13a, b is adjusted to accommodate the particular targets 24 being used by loosening the adjustment screw 18, moving the secondary tube 21 up or down to accommodate the target(s), and re-tightening the adjustment screw 18. The top and bottom edges of the desired target or targets 24 are extended over the upper and lower target support arms 13, respectively, and a number of target clasps 14 (preferably eight) are used to secure the targets 24 to the target support arms 13. The target stand device 10 is ready for use. The targets can be replaced as needed.

After target practice, the target clasps or other suitable attachment devices 14 are removed and the spent targets 24 are removed from the target support arms. The target support arms 13 are unscrewed, and the secondary tube 21 is telescoped into the primary tube 15 and locked into the closed position using the adjustment screw 18. The secondary tube is preferably simply a smooth sided tube section that fits tightly into the primary tube. The target support arms 13, and optionally the target clasps 14, are placed into the hollow of the secondary tube 21. The end plug 23 is placed in the upper end of the secondary tube 21, and the stand device 10 is ready for transport and storage (see FIG. 3).

Several types of target attachment devices 14 are suitable for use herein, including binder clips. Tubular C-shaped target clasps 14 are preferred. To use them, the user wraps the edge of the target 24 around the target support arm 13 and pushes the spaced apart C-shaped target clasps 14 over the target support arm. Alternatively, swinging clasps that swing over from the rear of the target support arm 13 may be employed once the target is in place. However, any target attachment device of a type suitable for this purpose can be used.

Several different target support arm coupling mechanisms 28 can be used herein, including a spring-loaded quick connect mechanism comprised of a male and female coupling. The end of the target support arm 13 comprises the male coupling, which preferably includes a cylindrical end holding a captive spring-loaded ball bearing(s). The male coupling fits closely into the female coupling, and is locked into place with the spring-loaded ball bearing. The female coupling is preferably a socket attached to the end of the primary tube at a transverse angle.

An alternate target support arm coupling mechanism 28 is a coupling thumb screw mechanism. The user slides the target support arm(s) 13 through a smooth bore coupling sleeve and uses a thumb screw to secure it in position. This allows centering of the target support arms respective to the primary or secondary tube and prevents the target support arm(s) from wobbling. The two upper support arms can be hinged together so that they fit down into the secondary tube.

Alternatively, a quarter turn bayonet-type target arm coupling mechanism can be employed. In this embodiment, the end of the target support arm 13 comprises a bayonet pin that fits into a corresponding receiver on the bayonet-type coupling. The target support arm is locked into place by turning the target support arm a quarter turn. The bayonet receiver coupling is on the end of the primary or secondary tube 15, 21. Both opposite sides of the bayonet receiver coupling receive ends of target support arms. However, any target arm coupling mechanism of a type suitable for this purpose can be used herein.

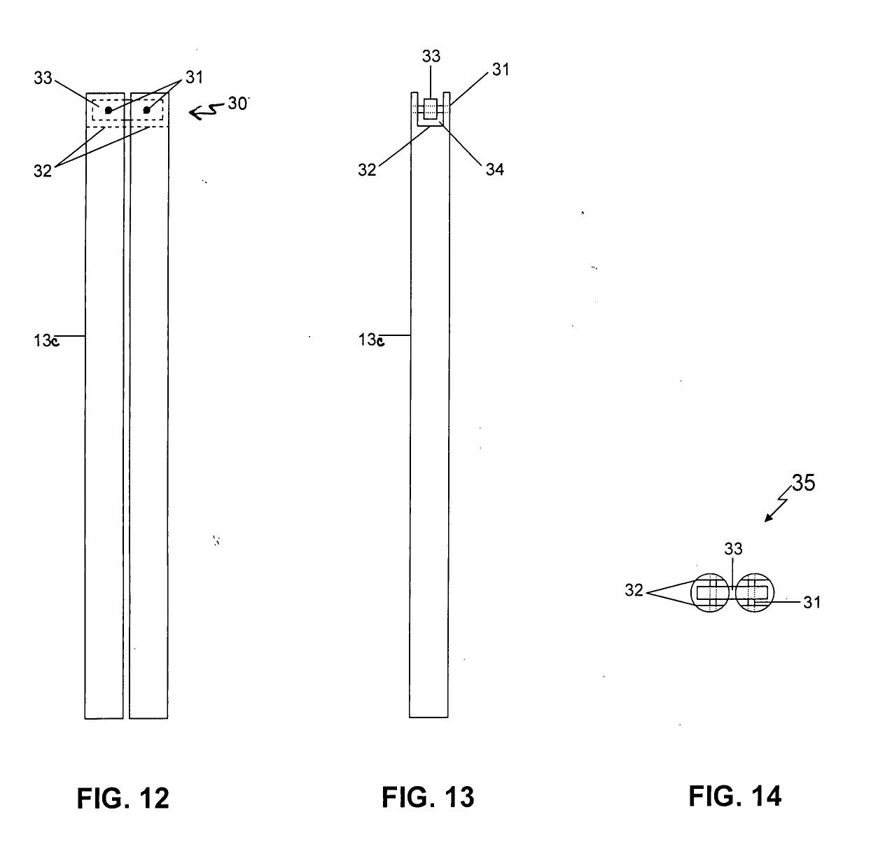

Turning to FIGS. 12-14, the target support arm coupling mechanism 28 alternatively is a hinge coupling assembly. The ends of two target support arms 13c are split to form a yoke assembly, as seen in FIG. 13. The target arm hinge coupling assembly 30 includes a metal hinge pin 31 that extends between the yokes 32 thus formed on the end of each target support arm (see FIGS. 12 and 14). The hinge coupling assembly 30 also includes a hinge plate 33 that extends through the gap 34 formed between the two yokes. The hinge plate 33 is transverse to the hinge pin 31. The hinge plate connects the two target support arms 13 together. When the target support arms 13c are not in use, they are folded down at the hinge assembly so that they are adjacent one another, as seen in FIG. 12. Thus, the target support arm hinge coupling assembly 30 comprises: a set of identical target support arms 13c, each target support arm 13c comprising a yoke assembly 32 at one end; a hinge plate 33 extending between the two target support arm yoke assemblies 32; a hinge pin 31 on each yoke assembly 32, each hinge pin 31 extending transversely through the hinge plate 33. The hinged target support arms 13c are foldable at the hinge coupling assembly 30 and insertable in the secondary tube 21.

Continuing with FIG. 14, to assemble the target stand device 10, the user unfolds the target support arms 13c and inserts the hinge assembly 30 portion of the set of target support arms 13c into a hinge coupling receiver 35 on the upper end of the secondary tube 21. Any suitable hinge coupling receiver for holding the set of target support arms 13c can be employed herein.

From the foregoing it can be realized that the described device of the present invention may be easily and conveniently utilized as a portable target stand. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A portable target stand device for supporting at least one shooting target in the ground, the device comprising:
(a) a lower stand assembly comprising a substantially hollow primary tube, and a slide hammer that is slidable up and down an outside portion of the primary tube;
(b) an upper stand assembly comprising a substantially hollow secondary tube with a smaller outside diameter than the inside diameter of the primary tube, the secondary tube being telescopable into and out of the primary tube;
(c) at least one removable target support arm, which is extendable at about a right angle from the primary tube or the secondary tube;
(d) at least one target support arm coupling mechanism for coupling the target support arms to the primary tube or secondary tube; and
(e) a plurality of target attachment devices for detachably attaching the target to the target support arm;
wherein the upper stand assembly is collapsible into the primary tube to form a compact, self-contained carrying case when the target stand device is not in use.

2. The device according to claim 1, wherein there are four of the at least one removable target support arms, two upper ones of which are extendable from opposite sides of the secondary tube, and two lower ones of which are extendable from opposite sides of the primary tube.

3. The device according to claim 2, further comprising an adjustable target support arm adjustment mechanism attached to the primary tube and controlling the distance between the upper and lower target support arms.

4. The device according to claim 1, wherein the upper stand assembly further comprises an end plug that is removably insertable into an end of the secondary tube.

5. The device according to claim 1, wherein the lower stand assembly further comprises a strike plate attached to the primary tube between the slide hammer and a lower, pointed end portion of the primary tube.

6. The device according to claim 3, wherein the target support arm adjustment mechanism is an adjustment screw coupled to a captive adjustment nut, the captive adjustment nut being attached to the primary tube, a portion of the adjustment screw contacting the portion of the secondary tube within the primary tube.

7. The device according to claim 1, wherein the at least one target support arm coupling mechanism is a lower target arm coupling nut attached to the primary tube, the at least one target support arm being removably insertable in the lower target arm coupling nut.

8. The device according to claim 7, wherein the at least one target support arm coupling mechanism is an upper target arm coupling nut attached to the secondary tube, the at least one target support arm being removably insertable in the upper target arm coupling nut.

9. The device according to claim 3, wherein the primary and secondary tubes are each generally square in shape, and the slide hammer is generally round in shape.

10. The device according to claim 3, wherein the target support arms, the secondary tube, and the primary tube are about the same length as one another.

11. The device according to claim 1, wherein the secondary tube has a larger inside diameter than the outside diameter of each of the target support arms, and the target support arms are insertable in the secondary tube.

12. The device according to claim 11, wherein the slide hammer has a larger inside diameter than the outside diameter of the smooth-faced primary tube.

13. The device according to claim 3, wherein the target attachment devices are target clasps.

14. The device according to claim 9, wherein the target attachment devices are tubular and C-shaped target clasps.

15. The device according to claim 1, wherein the target support arm coupling mechanism comprises a hinge coupling assembly.

16. The device according to claim 15, wherein the target support arm hinge coupling assembly comprises a set of identical target support arms, each target support arm comprising a yoke assembly at one end.

17. The device according to claim 16, wherein the target support arm hinge coupling assembly further comprises a hinge plate extending between the two target support arm yoke assemblies.

18. The device according to claim 16, wherein the target support arm hinge coupling assembly further comprises a hinge pin on each yoke assembly, each hinge pin extending transversely through the hinge plate.

19. The device according to claim 18, wherein the hinge coupling assembly is insertable into a hinge coupling receiver on an upper end of the secondary tube.

20. The device according to claim 18, wherein the hinged target support arms are foldable at the hinge coupling assembly and insertable in the secondary tube.
